(19) United States
(12) Patent Application Publication
(10) Pub. No.: US 2017/0370787 A1
(43) Pub. Date: Dec. 28, 2017

(54) Torsional Measurements Using an Optical non Contact Method

(71) Applicant: Siemens Energy, Inc., Orlando, FL (US)

(72) Inventors: David R. Tiffany, Winter Park, FL (US); Diatzikis V. Evangelos, Chuluota, FL (US); Benjamin E. Bassford, Orlando, FL (US)

(21) Appl. No.: 15/194,838

(22) Filed: Jun. 28, 2016

(51) Int. Cl. G01L 3/08; G01P 3/36; G01M 15/14

(52) U.S. Cl. CPC G01L 3/08; G01M 15/14; G01P 3/36

(57) ABSTRACT

A method to determine a characteristic on a turbine shaft is provided. The method includes disposing a reflective/absorptive target comprising a plurality of markings in a geometric pattern on the component. A light emitting source will then be focused onto a predetermined starting position on the target. The plurality of markings will linearly traverse across the light emitting source from the predetermined starting position. The reflected/absorbed light pulses from the plurality of markings will be detected and recorded. From the timing of the recorded light pulses, the characteristic of the component is determined. The geometric pattern comprises at least two non-parallel lines and a third line including the predetermined position. A system to determine a characteristic on a turbine shaft as well as a method to determine the torsional deflection of a turbine shaft are also provided.

### BACKGROUND

### 1. Field

The present application relates to large rotating equipment such as gas and steam turbines and particularly to a method to measure characteristics of a component on a turbine shaft. More particularly, the present application relates to a non-contact optical method and system to measure characteristics of a component on a turbine shaft.

### 2. Description of the Related Art

Gas and steam turbines are used to drive an electric generator in a power generating plant. Common to both the gas and steam turbine is a turbine shaft including components disposed along a longitudinal axis about which all the components making up the turbine shaft rotate. For a single shaft, combined cycle arrangement, the gas turbine and the steam turbine will share the same power generator. Thus, a typical method for measuring turbine output such as using the electrical output of the generator, will not be able to separate the individual power outputs for the gas turbine and steam turbine.

In order to properly diagnose issues with the various components making up the turbine shaft, the ability to make independent measurements of component characteristics, such as a torque from which power may be calculated, is desired. For example, service personnel may want to separate the contribution of individual components of a conventional gas and steam turbine arrangement such as the high, intermediate and low pressure steam turbines or the gas turbine compressor and turbine sections in order to isolate where a problem may be occurring on the turbine shaft. Independent torque measurements of the turbine shaft will allow for the various contributions of the shaft components to be broken out, allowing for better control and diagnosis of issues on the equipment. Currently, reliable and accurate independent torque measurements for the different components on the turbine shaft are difficult if not impossible to measure.

### SUMMARY

Briefly described, aspects of the present disclosure relates to a method to determine a characteristic for a component on a turbine shaft.

A first aspect of provides a method to determine a characteristic for a component on a turbine shaft. The method includes disposing a reflective/absorptive target comprising a plurality of markings in a geometric pattern on the component. A light emitting source will then be focused onto a predetermined starting position on the target. The plurality of markings will linearly traverse across the light emitting source from the predetermined starting position. The reflected/absorbed light pulses from the plurality of markings will be detected and recorded. From the timing of the recorded light pulses, the characteristic of the component is determined. The geometric pattern comprises at least two non-parallel lines and a third line including the predetermined position.

A second aspect provides a method to determine torsional deflection of a turbine shaft. The method includes disposing at least two reflective/absorptive targets comprising a plurality of markings in a geometric pattern on the component. A light emitting source will then be focused onto a predetermined starting position on each of the targets. The plurality of markings will linearly traverse across the light emitting source from the predetermined starting position. The reflected/absorbed light pulses from the plurality of markings will be detected and recorded. From the timing of the recorded light pulses from each target, the torsional deflection of the component is determined. At least two targets are disposed in different axial positions along the component. The geometric pattern comprises at least two non-parallel lines and a third line including the predetermined position.

A third aspect provides a system for determining a characteristic of a component on a turbine shaft. The system includes a component on the turbine shaft and a target including a plurality of markings in a geometric pattern disposed on the component. The system also includes a light emitting source focused on a predetermined starting position on the target and configured to pass linearly over the plurality of markings from the predetermined starting position to obtain spatial data corresponding to the plurality of markings. A detector receives and records light pulses reflected from/absorbed by the target. A processor is configured to determine a characteristic of the turbine shaft from the received light pulses. The geometric pattern comprises at least two non-parallel lines and a line including the predetermined starting position.

### BRIEF DESCRIPTION OF THE DRAWINGS

FIG. 1 illustrates a longitudinal partial perspective view of the mid-section of a gas turbine including two targets,

FIG. 2 illustrates a target, each unit cell of the target comprising three lines,

FIG. 3 illustrates a target, each unit cell of the target comprising four lines,

FIG. 4 illustrates a three line unit cell showing compensation for axial position with a known misalignment,

FIG. 5 illustrates a corresponding pulse train to the three line unit cell of FIG. 4,

FIG. 6 illustrates a four line unit cell showing compensation for axial position, as well as decoupling misalignment and shaft speed, and

FIG. 7 illustrates a corresponding pulse train to the four line target of FIG. 6.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

The ability to measure certain characteristics of the turbine shaft at certain axial positions along the turbine shaft would be beneficial for pinpointing a location along the turbine shaft where a problem is occurring and/or how much power may be output and/or consumed in the different turbine sections, for example. Characteristics of the turbine shaft components that may be useful for diagnosing problems would be shaft speed, axial (or thrust) position, and torsional (or angular) deflection. For example, from the angular deflection of the shaft of known stiffness measured at two locations on the turbine shaft, a torque at that location of the shaft may be calculated. Using the measured torque and a speed measurement, a power output or a power consumption at that position on the shaft may be obtained.

Various solutions have been developed to measure shaft deflections. For example, surface wave acoustics and some magneto-strictive techniques are capable in theory of making an angular deflection measurement at a position on the shaft without modifications to the shaft, however, these methods are unreliable in practice. Additionally, some methods such as strain gauges and magneto-strictive techniques use devices that need to be mounted on the shaft, thus requiring undesirable modifications to the shaft. Other methods may use magneto-electric devices, the electro-magnetic effects of which may interfere with the operation of the shaft. Thus, a method of measuring characteristics of the turbine shaft that overcome these disadvantages is desired.

In response to finding an improved method of measuring characteristics of a component on a turbine shaft, a non-contact optical method and system of measuring characteristics of a component was developed and will be described. The method and system positions a light emitting source at a distance from the turbine shaft and directs the light emitting source at an optical target disposed on the turbine shaft. The target would not modify the turbine shaft in any way, but would simply be disposed on or adhere to the turbine shaft component. The weight of the target would be negligible in comparison to the turbine shaft component. A receiver, which may be disposed in the vicinity of the light emitting source, may be configured to receive light pulses generated by either reflection from or absorbtion of by the target. From the received light pulses, a processor may determine a characteristic of the turbine shaft.

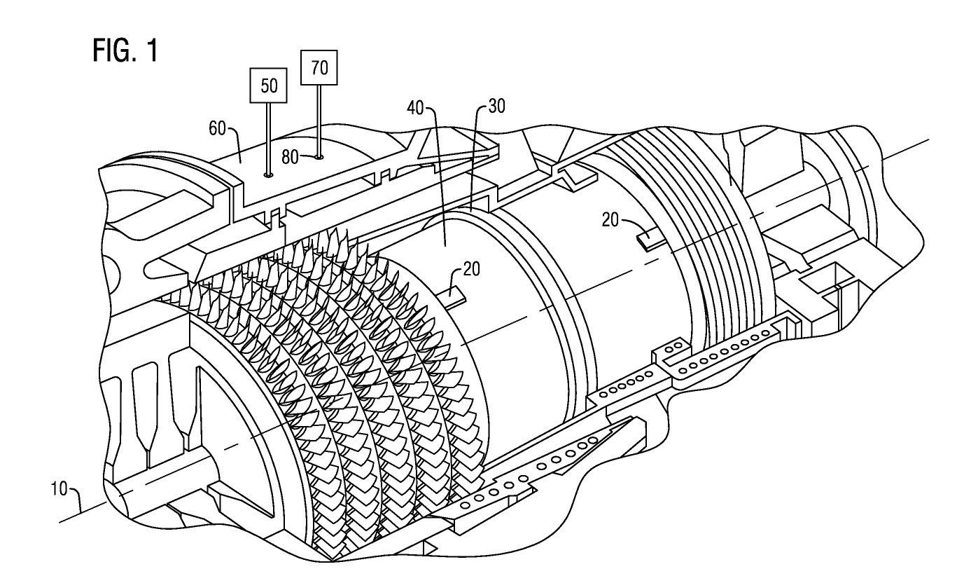

In the embodiment shown in FIG. 1, two targets 20 are spaced axially along a torque tube 40 of a gas turbine shaft 30. The torque tube 40 and other components comprising the turbine shaft 30 are spaced along the longitudinal axis 10 of the turbine shaft 30. The torque tube 40 is a component on a turbine shaft 30 between the compressor and turbine section of the gas turbine. In this embodiment, the light emitting source 50 is carried by an optical fiber internal to the turbine casing 60 and positioned a distance from and perpendicular to the turbine shaft 30. The signal in this embodiment is carried by another optical fiber to the detector 70 positioned next to the light emitting source 50 just outside a port in the turbine casing 60. As illustrated, a thin two dimensional target 20 may be adhered to the turbine shaft 30. The two targets 20 do not necessarily have to be aligned in the axial direction such that their centrelines are collinear in order to measure a characteristic of a component on a turbine shaft according to the proposed method and system.

In an alternate embodiment, a light emitting source 50, such as a laser, may be disposed just inside a port 80 in the turbine casing 60 or external to the turbine casing 60 such that it is positioned a distance from and perpendicular to the turbine shaft 30. For example, a laser 50 may be disposed external to the turbine casing 60 at a location where the shaft 30 is exposed such as the shaft connecting the turbine to the generator coupling. In this alternate embodiment, the detector 70 may be positioned next to the light emitting source 50.

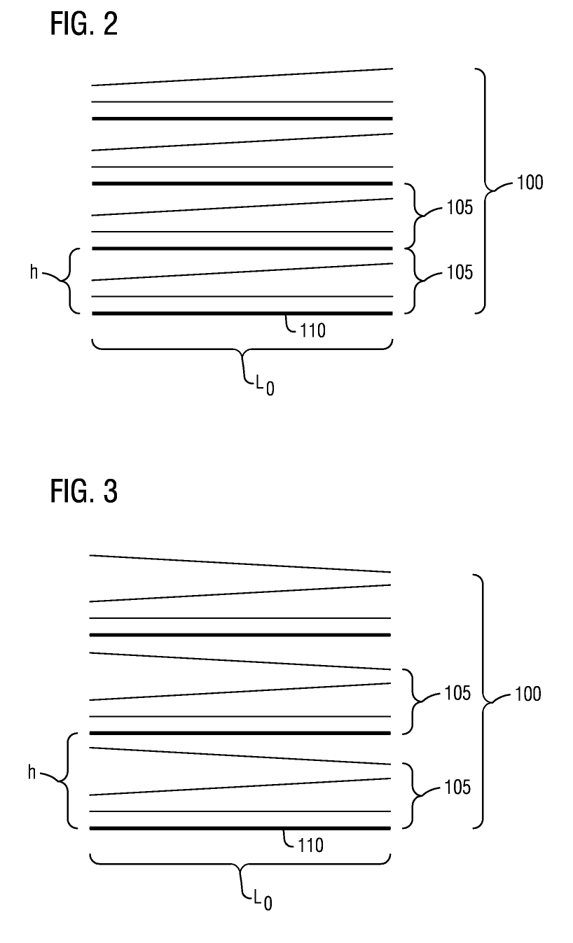

A target 100, as shown in FIGS. 2-3, may include a plurality of markings in a geometric pattern. The target 100 may comprise a plurality of unit cells 105. In the embodiments of FIGS. 2-3, the geometric pattern of the plurality of markings may include a plurality of lines. However, other geometric patterns may also be possible as long as there are sufficient degrees of freedom to account for any fixed (i.e., uncalibrated) factors. A width of the target L₀ may be in a range of ½ inch to 2 inches. A target 100 in this range would be wide enough to cover a typical movement range of the turbine shaft 30. A height h of the unit cell 105 may be fractions of an inch, with the exact dimensions dependent on the pattern geometry and the method of generating the markings.

The plurality of markings may include a reflective/absorptive material. For example, the reflective material may be a gold film which is a relatively reflective, yet unreactive material which would be beneficial in the extremely hot, corrosive environment of a gas and/or steam turbine. The gold film may be disposed on a substrate creating the target 100. The target 100 may then be cemented on the turbine shaft 30. One skilled in the art would understand that other materials may be used for the markings. One consideration to be taken into account when choosing the materials of the target would include where the target would be disposed on the turbine shaft 30. Some locations on the turbine shaft 30 experience significantly higher operating temperatures than others. For instance, a shaft location within the compressor section is significantly cooler than a shaft location in the mid-section of the turbine. Additionally, in another embodiment an inverse target may be used such that the space between the plurality of markings comprises a reflective/absorptive material and the markings merely comprise the background material of the substrate. In this embodiment, the reflected/absorbed pulses would designate the light-emitting source 50 passing over the non-reflective/non-absorptive material.

FIG. 2 illustrates an embodiment including a target 100 comprising a plurality of unit cells 105, each unit cell 105 comprising three lines. FIG. 3 illustrates a further embodiment including a target 100 comprising a plurality of unit cells 105, each unit cell 105 comprising four lines. In both embodiments, the bottom line of each unit cell 105, the first line, in the geometric pattern may have a slightly thicker width than the other lines in order to designate a predetermined starting position 110 on the unit cell 105. A second line adjacent to the first line may be parallel to the bottom line. A third line above the second line may lie at a known angle to the first line. In the further embodiment of FIG. 3, a fourth line may not be parallel to any of the other lines.

In an embodiment, the light emitting source 50 may be embodied as a laser. Using a laser as the light emitting source 50 may be more convenient when the turbine shaft 30 is exposed as in this case there would be an unblocked perpendicular path from the laser 50 to the turbine shaft 30. One such exposed location on the turbine shaft 30 would be where the shaft 30 connects the turbine to the generator coupling. The detector 70 may be embodied as an optical filter, photo multiplier tube, or a photo cell for example. The spacing between the light emitter 50 and the detector 70 should be small enough relative to the distance of both from the turbine shaft 30 such that the detector 70 may also be perpendicular to the turbine shaft 30. Such a spacing would enable the detector 70 to receive a fairly strong back scatter of light. In another embodiment, the light emitting source 50 may be embodied as high temperature fiber optics disposed within the turbine casing 60. In this embodiment, the high temperature fiber optics carry both the light source and the detector channels.

The target 100 may comprise a cascade of repetitive markings as shown in FIGS. 2 and 3. Including a cascade of repetitive markings may be beneficial for fault detection. For example, an initial thicker line would indicate the start of a pattern, and the results of the pulse train reflected/absorbed from the target 100 may be ignored if the requisite number of pulses did not occur before the next thick line was observed. Outliers based on repeated measurements may also be determined and thrown out of the average calculation.

A processor may be configured to determine a characteristic of the turbine shaft 30 from the light pulses received from the detector 70. The processor used may be a low cost commercially available hardware programmable logic controller.

Referring to FIGS. 1-7, a method to determine a characteristic for a component on a turbine shaft 30 is also provided. In a first step a target 100 comprising a plurality of markings in a geometric pattern is disposed onto the turbine shaft 30. The disposing may simply include adhering a two-dimensional adhesive target 100 to the turbine shaft 30. No machining or other modification to the turbine shaft 30 would be needed using the proposed optical non-contact method.

As discussed previously, a target 100 as shown in FIG. 2 illustrates a plurality of unit cells 105, each unit cell comprising three lines. In order to accurately determine the characteristic of the component 40, the angle of the target 100 relative to the axis 10 of the shaft would need to be measurable. In contrast, the target 100 comprising a plurality of unit cells, each unit cell comprising four lines as shown in FIG. 3, includes a sufficient degree of freedom to measure the target's angle relative to the axis 10 of the shaft.

The plurality of markings may comprise a reflective and/or absorptive material. Numerous ways exist in order to generate a pulse train from the interrogation of the plurality of markings. For example, the absorption of the light emitted from the light emitting source 50 by the plurality of markings or the reflection of light from the light emitting source 50 by the plurality of markings could both generate a pulse train when the light emitting source 50 passes over the plurality of markings.

A light emitting source 50, disposed at a distance from the target 100, may then be focused onto a predetermined starting position 110 on the target 100 from a position perpendicular from the turbine shaft 30. As discussed previously, the predetermined starting position 110 may include a thicker line than the thickness of other markings in the target 100 in order to distinguish it from the other markings. As the turbine shaft rotates, the plurality of markings may linearly cross the path of the light-emitting source 50. The light is reflected/absorbed from the target 100. The detector 70 records the reflected/absorbed light pulses from the plurality of markings.

From the plurality of light pulses, the processor may determine a characteristic of the turbine component 40 on the turbine shaft 30.

The characteristics of the turbine shaft that may be determined using the proposed method may be shaft speed, axial (thrust) position, and torsional (angular) deflection. The shaft speed describes how fast the turbine shaft is rotating, the axial position describes how far the turbine shaft has moved along the longitudinal axis 10 and torsional deflection measures a twisting of the shaft, which characteristic requires a measurement of angular deflection at one position of the shaft 30 relative to another location on the shaft 30. Measuring speed and thrust would only require one target 100 disposed in a location on the turbine shaft 30 while measuring torque would require two targets 100 spaced axially on the turbine shaft 30.

Using the timing of the pulse train created by the reflection/absorption of the light emitting source 50 passing over the plurality of markings, the characteristic of the turbine component may be calculated. Known spatial data between the plurality of markings may also be used in this calculation.

An embodiment of a target comprising two lines parallel to the longitudinal axis 10 may be used in order to determine the speed of the rotating turbine shaft 30. With this embodiment the timing between the reflected pulses would be used to calculate the speed of the rotating turbine shaft 30. The torsional deflection of the turbine shaft 30 may be determined using two targets, each comprising two parallel lines, spaced an axial distance from one another along the longitudinal axis 10. However, it may be difficult to adhere each target such that the lines of the target are perfectly parallel to the longitudinal axis 10 of the turbine shaft 30.

In order to account for a misalignment that may occur between a target's centerline and the longitudinal axis 10 of the turbine shaft 30, a target 100 including a third line at a known angle to at least one other line on the target as shown in the embodiment of FIG. 2, may be used to determine the displacement along the longitudinal axis 10 of the shaft 30 relative to the target 100.

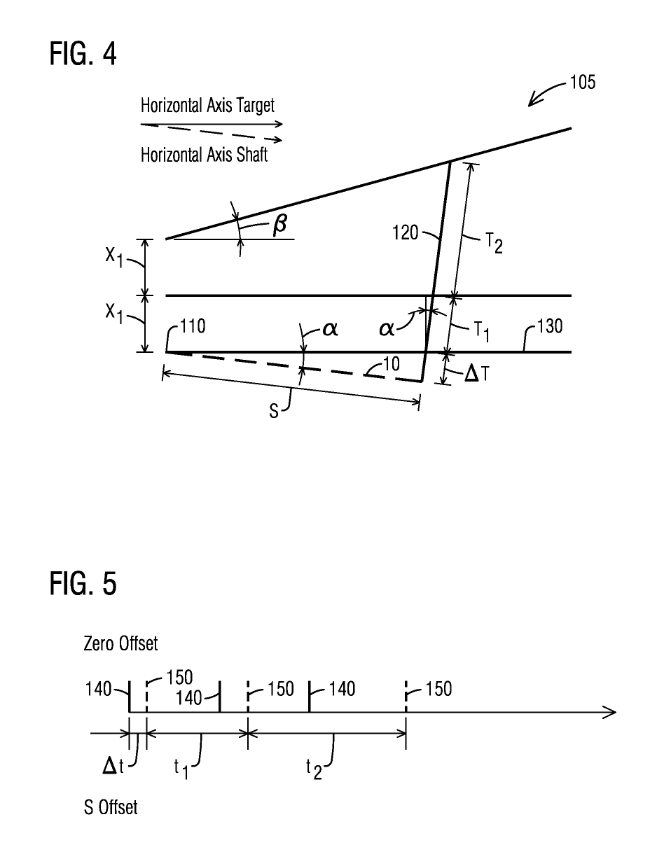

For example, FIG. 4 illustrates a three line unit cell 105 of a target 100 as shown in FIG. 2, as well as the trajectory 120 of the light emitted by the light emitting source 50 during a partial rotation of the turbine shaft 30. Because the parallel lines designating the centerline of the target 130, do not lie parallel to the longitudinal axis 10 of the turbine shaft 30, an angular offset a, exists between the first line 130 on the unit cell 105 and the longitudinal axis 10. The line S denotes the displacement along the longitudinal axis 10 of the turbine shaft 30 relative to the bottom left corner or predetermined starting postion 110 of the unit cell 105. FIG. 5 illustrates corresponding pulse train created by the light being reflected/absorbed from/by the three lines of the unit cell 105 of FIG. 4 as the plurality of markings linearly traverse the light emitting source along the trajectory 120. The pulses 140 include a zero offset which would occur if the centreline of the target 130 and the longitudinal axis of the target 10 were aligned. However, in the illustrated example, the centerline of the target 130 and the longitudinal axis are not aligned. Thus, an offset, denoted by S offset in FIG. 5, exists. The pulses 150 correspond to the light being reflected/absorbed from/by the three lines of the unit cell 105 according to the trajectory 120 of the light emitting source.

In this example shown in FIG. 4, the misalignment of the target, and hence the angle α, is known. Using trigonometric relational data including the known angle β and the timing between the pulses t₁,t₂, one can determine the axial position on the target S, the speed V, and the offset, ΔT. One skilled in the art would be able to derive the needed equations from the known spatial data and trigonometric relationships to determine the desired characteristics of the component.

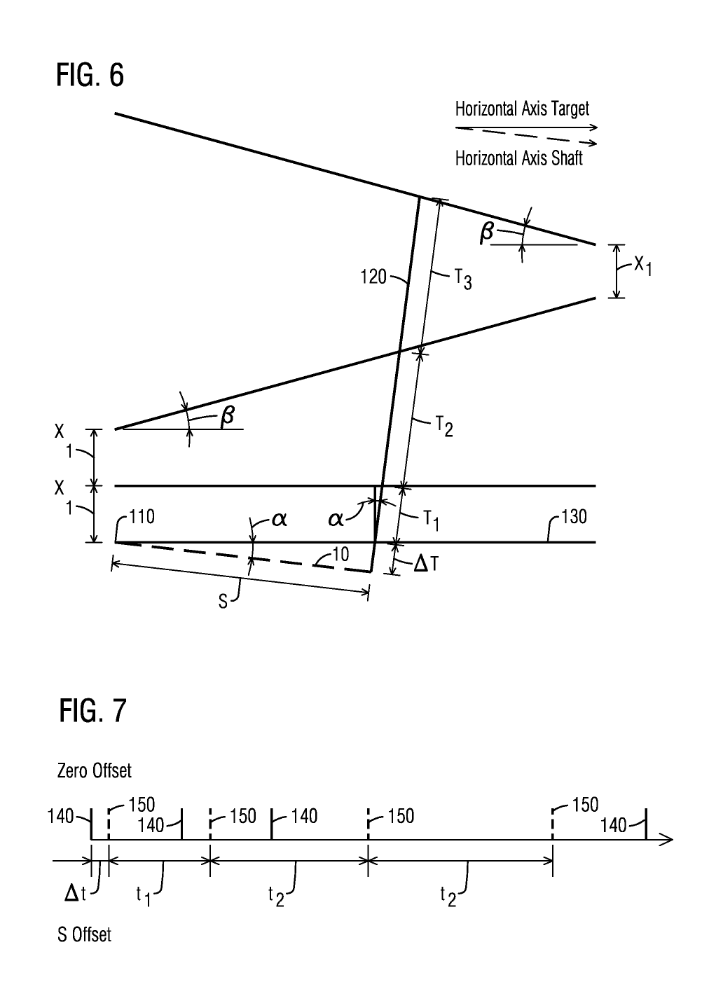

In another example, when the misalignment of the target 100, and hence the angle α, is not known, the speed measurement may be decoupled from the angle α using a fourth line angled opposite to the third line and at the known angle β to one of the parallel lines, the first and second lines designating the centerline of the target, as illustrated by the target 100 shown in FIG. 3. FIGS. 6 and 7 illustrates a four line target as shown in FIG. 3, as well as a trajectory 120 the light emitted by the laser traverses during a partial rotation of the turbine shaft 30. Similarly to the previous example, the axial position S may be determined using trigonometric relations with known spatial data. Additionally, the misalignment and the shaft speed V may be decoupled. For example, a clockwise misalignment of the target 100 in the configuration as illustrated in FIG. 6 leads to T2 lengthening and T3 shortening, thus allowing for misalignment to be determined independent of shaft speed V. FIG. 7 illustrates corresponding pulse train created by the light being reflected/absorbed from/by the four lines of the target of FIG. 6 as the plurality of markings linearly traverse the light emitting source 50 along the trajectory 120. The pulses 140 include a zero offset which would occur if the centreline of the target 130 and the longitudinal axis of the target 10 were aligned. However, in the illustrated example the centreline of the target 130 and the longitudinal axis 10 are not aligned. Thus, an offset, S offset in FIG. 7, exists. The pulses 150 correspond to the light being reflected/absorbed from/by the four lines of the unit cell 105 according to the trajectory 120 of the light emitting source 50.

Many other configurations of lines may be used as long as there are sufficient degrees of freedom to decouple all the variables involved in the calculations.

The teaching has shown that with a single target, the speed and thrust position may be measured. However, it may be desirable to measure the angular deflection which along with shaft torsional stiffness may yield torque. In order to calculate the torsional deflection along a section of the turbine shaft 30, the above described method may be used for each of at least two targets 100 disposed in different axial positions along the turbine shaft. Thus, a method for determining torsional deflection is also provided.

Similarly to the previously described method of determining a characteristic of a turbine shaft 30, the method of determining torsional deflection of a turbine shaft 30 disposes at least two targets 100 including a plurality of markings in a geometric pattern on the component. Each geometric pattern on the at least two targets 100 includes at least two non-parallel lines and a third line including the predetermined starting position. A precise circumferential alignment between the at least two targets is not necessary as the misalignment may be calibrated out using the method. This simplifies the installation of the targets onto the turbine shaft 30 as a perfect alignment of the at least two targets 100 would not be critical to the measurement of the angular deflection.

The described methods and system to determine specific characteristics of a turbine shaft 30 include significant advantages over prior art methods. For example, the turbine shaft 30 does not require modifications beyond a simple adhesive target 100. Additionally, the presented non-contact optical method does not require electronics to be mounted on the turbine shaft. The proposed methods may be performed during normal and testing operation. Different embodiments of the light emitting source 50 may be applied internally and externally to the turbine casing depending on the precise location along the turbine shaft that measurements will be taken. Lastly, the method is relatively inexpensive to implement.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method to determine a characteristic for a component on a turbine shaft, comprising:
disposing a reflective/absorptive target comprising a plurality of markings in a geometric pattern on the component;
focusing a light emitting source onto a predetermined starting position on the target;
linearly traversing the plurality of markings across the light emitting source from the predetermined starting position;
detecting light pulses reflected/absorbed from the plurality of markings;
recording the detected light pulses; and
determining the characteristic of the component using the timing of the recorded light pulses,
wherein the geometric pattern comprises at least two non-parallel lines and a third line including the predetermined starting position.

2. The method as claimed in claim 1, wherein the determining further includes calculating the characteristic using the timing of the recorded light pulses and known spatial data between the plurality of markings.

3. The method as claimed in claim 2, wherein the calculating includes taking into account a misalignment between the centerline of the target and the axis of rotation of the shaft.

4. The method as claimed in claim 3, wherein the plurality of markings includes a number of markings used for the target such there is at least a sufficient degree of freedom to decouple all of the plurality of variables involved in the calculation.

5. The method as claimed in claim 1, wherein a first line of the at least two non-parallel lines lies at a known angle β to a second line of the at least two non-parallel lines.

6. The method as claimed in claim 5, wherein the plurality of markings includes at least four lines.

7. The method as claimed in claim 6, wherein a fourth line is angled opposite to first line at the known angle β to the second line.

8. The method as claimed in claim 1, wherein the target comprises a cascade of repetitive markings.

9. The method as claimed in claim 8, further comprising determining a fault condition when the requisite number of pulses does not occur before a light pulse is detected from a further predetermined starting position.

10. The method as claimed in claim 1, wherein the determined characteristic is shaft speed.

11. The method as claimed in claim 1, wherein the determined characteristic is axial position of the shaft (thrust).

12. The method as claimed in claim 1, wherein the focusing includes disposing the light emitting source at a distance from the turbine shaft.

13. The method as claimed in claim 1, wherein the disposing includes adhering the target 100 onto the component.

14. A method to determine torsional deflection of a turbine shaft, comprising:
disposing at least two reflective/absorptive targets comprising a plurality of markings in a geometric pattern on the component;
focusing a light emitting source onto a predetermined starting position on each of the targets;
traversing the plurality of markings across the light emitting source;
recording light pulses absorbed from the plurality of markings; and
determining the torsional deflection of the component from the timing of the recorded light pulses from each of the targets;
wherein the at least two targets are disposed in different axial positions along the component, and
wherein the geometric pattern comprises at least two non-parallel lines and a third line including the predetermined starting position.

15. A system for determining a characteristic of a component on a turbine shaft, comprising:
a component on the turbine shaft;
a target including a plurality of markings in a geometric pattern disposed on the component;
a light emitting source focused on a predetermined starting position on the target and configured to pass linearly over the plurality of markings from the predetermined starting position to obtain spatial data corresponding to the plurality of markings;
a detector to receive and record light pulses reflected from/absorbed by the target;
a processor configured to determine a characteristic of the turbine shaft from the received light pulses,
wherein the geometric pattern comprises at least two non-parallel lines and a line including the predetermined starting position.

16. The system as claimed in claim 15, wherein a width of the target is in a range of ½ inch to 2 inches, and the height of the target is greater than 0 and ≦1 inch.

17. The system as claimed in claim 15, wherein the plurality of markings includes at least four lines.

18. The system as claimed in claim 15, wherein a first line of the two non-parallel lines lies at a known angle β to a second line of the two non-parallel lines.

19. The system as claimed in claim 15, wherein a third line including the pre-determined starting position includes a thicker width than the other two lines in order to designate the predetermined starting position.

20. The system as claimed in claim 15, wherein the plurality of markings comprise a reflective/absorptive material.
